(19) United States
(12) Patent Application Publication
(10) Pub. No.: US 2020/0039448 A1
(43) Pub. Date: Feb. 6, 2020

(54) VEHICULAR CAMERA SYSTEM WITH DUAL VIDEO OUTPUTS

(71) Applicant: Magna Electronics Inc., Auburn Hills, MI (US)

(72) Inventors: Yuesheng Lu, Farmington Hills, MI (US); Jonathan D. Conger, Berkley, MI (US); Steven V. Byrne, Goodrich, MI (US); Vivek Vaid, South Lyon, MI (US)

(21) Appl. No.: 16/527,652

(22) Filed: Jul. 31, 2019

Related U.S. Application Data
(60) Provisional application No. 62/713,084, filed on Aug. 1, 2018.

(51) Int. Cl. B60R 11/04; B60R 1/00; H04N 7/18

(52) U.S. Cl. CPC B60R 11/04; B60R 1/00; B60R 2300/8066; B60R 2300/30; H04N 7/18

(57) ABSTRACT

A vehicular vision system includes a camera disposed at a vehicle and having a field of view exterior of the vehicle. The camera comprises an imager that captures image data. The camera comprises first and second outputs that output a respective data stream. A display device receives a first data stream from the first output of the camera, and a machine vision electronic control unit (ECU) receives a second data stream from the second output of said camera. The machine vision ECU processes the second data stream for at least one driving assist feature of the vehicle. The display device receives the first data stream and displays video images at a display screen of the display device for viewing by an occupant of the vehicle.

### CROSS REFERENCE TO RELATED APPLICATION

The present application claims the filing benefits of U.S. provisional application Ser. No. 62/713,084, filed Aug. 1, 2018, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras (preferably one or more CMOS cameras) to capture image data representative of images exterior of the vehicle, and provides a dual output camera that outputs respective data streams to a machine vision ECU (electronic control unit) and to a display ECU (such as a display unit or a surround view system ECU). The camera captures image data via an imager and splits the image data into two outputs for processing by the respective ECUs.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a schematic for a surround view system with single output cameras and a dual output ECU;

FIG. 3 is a schematic for a surround view system with a dual output camera and a single output ECU;

FIG. 4 is a schematic for a system with a dual output camera and a machine vision ECU and a separate display;

FIG. 5 is a perspective view of a camera PCB with a dual coaxial header;

FIG. 6 is a perspective view of the camera showing the rear housing with a dual coaxial connector; and

FIG. 7 is a perspective view of a camera where a dual connector FAKRA cable connects to the camera.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

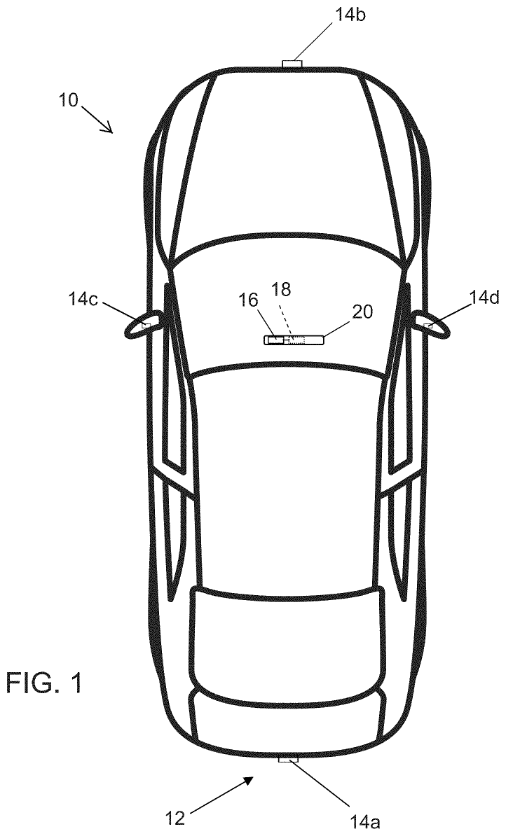

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

In automotive camera systems, there are needs to output camera or camera system images or image data to two or more receiving devices. For example, one receiving device may be the display in the head unit that displays real time video to the driver, while another receiving device may be the machine vision ECU that processes image data and runs detection algorithms (object detection, object classification, pedestrian detection, trailer angle detection, etc.). Due to the requirements of the image processing, which are different between the head unit display and the machine vision ECU, a camera or camera system outputs two different video streams.

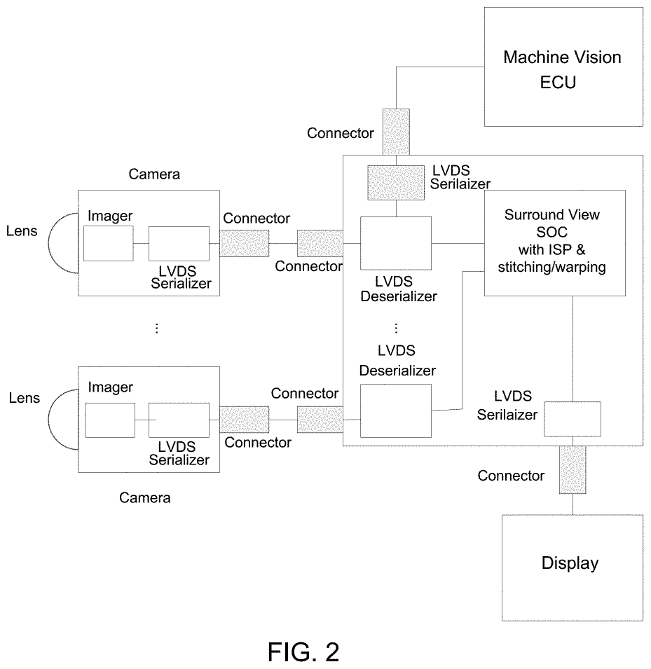

With reference to FIG. 2, a surround view ECU includes a deserializer (such as an LVDS deserializer, such as, for example, a TI DS90UB954 deserializer) that is capable of outputting two duplicated video data streams, either in parallel digital format or in MIPI CSI-2 format. One data stream goes to a surround view system-on-chip (SOC) for surround view processing, such as image signal processing (ISP), image stitching, image warping, etc., and is eventually output through a LVDS (low voltage differential signaling) serializer of the ECU to a display in a head unit. The other data stream that is output by the deserializer is communicated to another LVDS serializer as a pass-through and is output to a machine vision ECU for machine vision processing of the captured image data (such as for a driving assist system or function).

What is sent to the machine vision ECU is video image data in raw format, for instance Bayer or Red, Green, Green, Blue pixel format. The machine vision ECU will process the Bayer data format with its ISP and run other image processing steps or algorithms. If some type of pre-processing is needed in the surround view ECU before sending the stream to the machine vision ECU, a processing unit can be added to the surround view ECU between the LVDS deserializer and the LVDS serializer, instead of the illustrated direct pass-through video data.

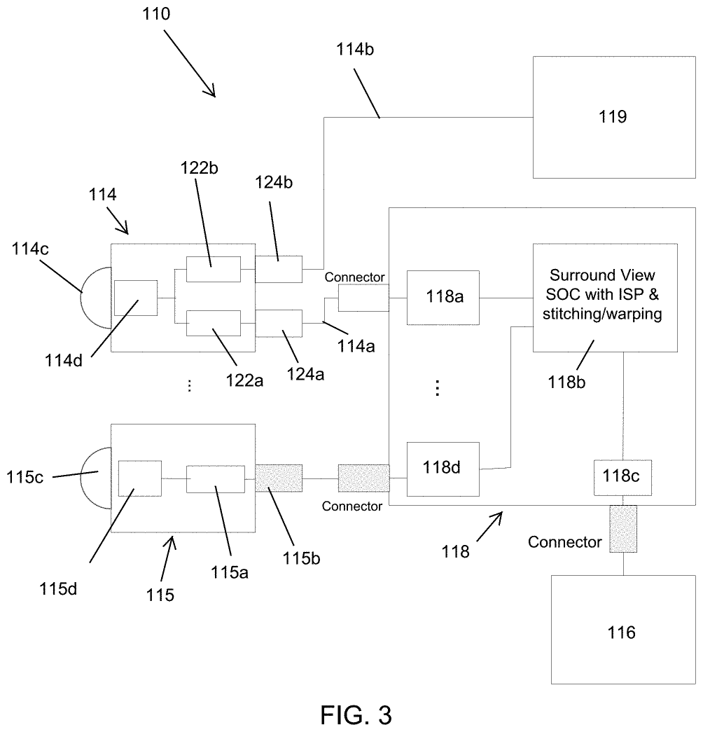

As shown in FIG. 3, a vehicular vision system 110 includes a camera 114 with dual video output working with multiple other cameras 115 (one shown) with single video output, and includes a surround view ECU 118 and a machine vision ECU 119. With respect to the camera 114 with dual video output, one of the outputs 114a (output at a first output connector 124a of the camera that is in communication with a first LVDS serializer 122a of the camera) is sent to the surround view ECU 118 (and received at a LVDS deserializer 118a of the surround view ECU 118). After processing of the image data at the surround view system-on-chip (SOC) 118b of the ECU 118, the ECU 118 outputs video image data via a LVDS serializer 118c to a display 116 (such as a head unit having a video display screen for displaying video images for viewing by a driver of the vehicle). The other video data output 114b of the camera 114 (output at a second output connector 124b of the camera that is in communication with a second LVDS serializer 122b of the camera) is sent to the machine vision ECU 119 for machine vision processing of the captured image data (such as for object detection, pedestrian detection, lane marker detection and/or the like).

Each camera 114, 115 includes a lens 114c, 115c and an imager 114d, 115d. The other cameras 115 also include an LVDS serializer 115a and a connector 115b, which outputs to an LVDS deserializer 118d at the surround view ECU 118 for providing the data to the surround view processor or chip 118b of the surround view ECU 118. The data provided to the surround view chip processor 118b is processed and dewarped and stitched to generate a surround view video image data stream for providing to the display 116, where video images derived from the captured image data are displayed at a video display screen for viewing by a driver of the vehicle.

Thus, there are two LVDS serializers 122a, 122b at the camera 114 that each receive image data captured by the imager 114d and provided via parallel digital lines or MIPI CSI-2 lines, and that each output respective video data streams 114a, 114b via the two independent output connectors 124a, 124b. The first output 114a is received at a connector and a LVDS deserializer 118a of the surround view ECU 118, and the second output 114b is provided to a separate machine vision ECU 119. The camera 114 may comprise a rear backup camera or a windshield mounted forward viewing camera that captures image data for display of video images (along with video images derived from image data captured by the other cameras 115) and that captures image data for machine vision processing (such as for a driving assist system of the vehicle). The image data streams are split in the camera and communicated to the surround view ECU and the machine vision ECU from the camera, such that a separate output is not needed at the surround view ECU.

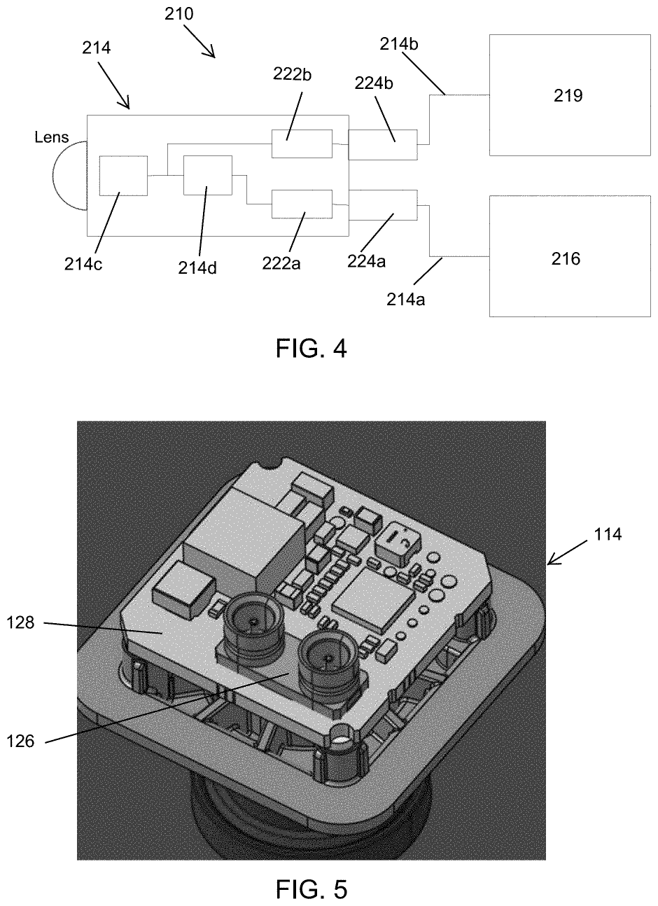

As shown in FIG. 4, a vehicular vision system 210 includes a camera 214 with dual video outputs or data streams 214a, 214b that, without a surround view ECU, output directly to a display 216 of a head unit and a machine vision ECU 219. As the machine vision ECU 219 expects a raw pixel data with Bayer format, the LVDS serializer 222b takes pixel data directly from imager 214c of the camera 214 and the camera outputs the data stream 214b (via the output connector 224b) to the machine vision ECU 219. The other LVDS serializer 222a of the camera 214 takes processed pixel data (for example in YUV422 or RGB888 format), as processed at an ISP chip or processor 214d of the camera, and the camera outputs (via the output connector 224a) the output data stream 214a to the display 216 of head unit, where video images derived from the captured image data are displayed at a video display screen for viewing by a driver of the vehicle.

The camera may comprise any suitable connectors for electrically connecting the camera lines to wires or a communication bus of the vehicle to communicate the respective data stream to the machine vision ECU and/or display and/or surround view ECU. In the illustrated embodiment (see FIG. 5), the camera 114 includes a dual coaxial LVDS header assembly 126 on a PCB 128. The header assembly 126 includes two coaxial connectors and a plastic holder that is insert injection molded with the two coaxial connectors. The reason for this design is to achieve a well-controlled distance tolerance between the two coaxial connectors. Tight tolerance is required for the two coaxial connector pair to be mated with two coaxial connectors at or in the rear cover. Another reason of such a closely positioned coaxial connector in one piece is to eliminate the large footprint required if two separate coaxial connectors are designed into the mechanical housing and PCB.

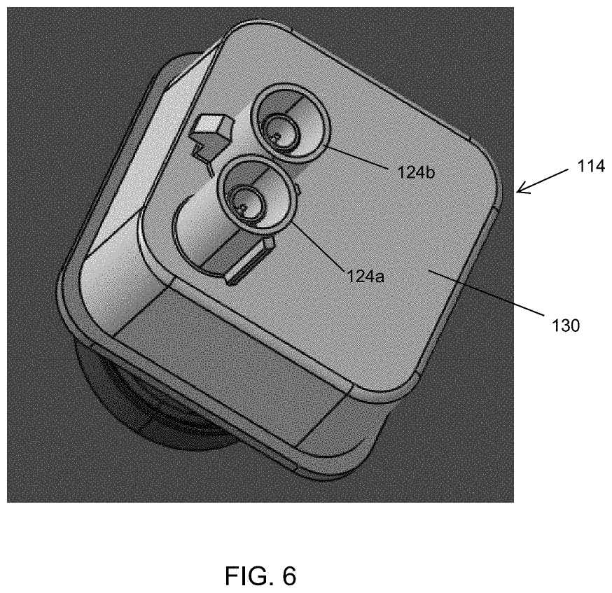

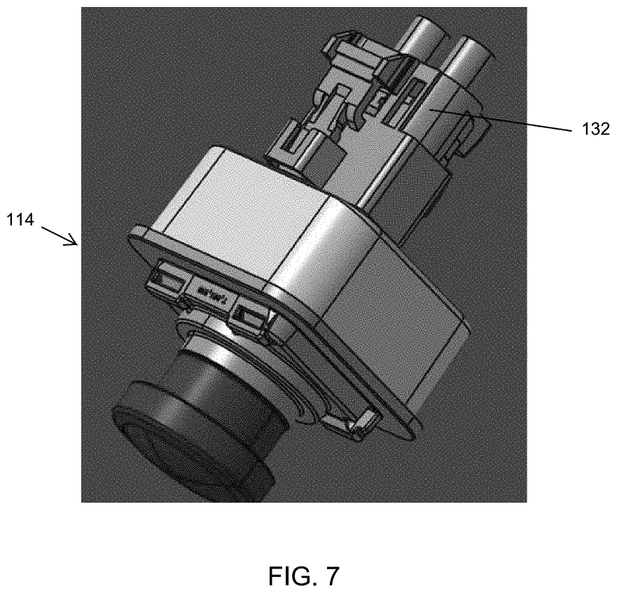

FIG. 6 shows the dual coaxial connectors 124a, 124b as the part of camera rear cover 130. Two FAKRA connector inserts are insert-molded into the rear cover plastic body. FIG. 7 shows a single cable connector 132 that is plugged into or connected to the dual coaxial connectors at the camera rear housing. The cables may then be split to carry the signals or data streams to the respective processor or ECU. By such a design as depicted in FIGS. 5-7 (having the two output connectors in side-by-side relationship so a single connector connects thereat), a small camera housing or reduced profile housing is possible. Two separate and individual connectors would result in a much larger PCB and larger camera housing, which is not desired in camera packaging for a vehicle.

The camera and vision system of the present invention does not limit to LVDS signal type only. It can be applied to other video signal transmission types, such as, for example, NTSC, Ethernet, and/or digital video transmitted over analog cables (for example, the technologies developed by Analog Devices C2B or Techpoint's HD-TVI or the like).

The camera may include electrical connecting elements that accommodate tolerances in the housing and/or PCB mounting and/or connector portion. The electrical connecting elements may utilize aspects of the cameras and electrical connectors described in U.S. Pat. No. 9,233,641 and/or U.S. Publication Nos. US-2013-0242099; US-2014-0373345; US-2015-0222795; US-2015-0266430; US-2015-0365569; US-2016-0037028; US-2016-0268716; US-2017-0133811; US-2017-0295306 and/or US-2017-0302829, which are hereby incorporated herein by reference in their entireties. Optionally, the electrical connections may be established via molded interconnect device (MID) technology, such as by utilizing aspects of the cameras described in U.S. Publication Nos. US-2018-0072239; US-2017-0295306 and/or US-2016-0037028, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, said vehicular vision system comprising:
a camera disposed at a vehicle and having a field of view exterior of the vehicle;
wherein said camera comprises an imager that captures image data;
wherein said camera comprises a first output connector and a second output connector, and wherein, during operation of said camera, a first data stream is output by said camera via said first output connector and a second data stream is output by said camera via said second output connector;
a display device that receives the first data stream output by said camera via said first output connector;
an electronic control unit (ECU) that receives the second data stream output by said camera via said second output connector;
wherein said ECU comprises an image processor that processes the second data stream for at least one driving assist feature of the vehicle; and
wherein said display device receives the first data stream and displays video images derived from the first data stream at a display screen of said display device for viewing by an occupant of the vehicle.

2. The vehicular vision system of claim 1, wherein said camera comprises (i) a first low voltage differential signaling (LVDS) serializer that receives raw image data captured by said imager and outputs serialized data to said first output connector, and (ii) a second LVDS serializer that receives raw image data captured by said imager and outputs serialized data to said second output connector.

3. The vehicular vision system of claim 1, wherein said display device comprises a display ECU that receives the first data stream output by said camera via said first output connector and processes the first data stream for displaying video images derived from the processed first data stream at the display screen.

4. The vehicular vision system of claim 3, wherein said display ECU receives the first data stream output by said camera via said first output connector and that receives data streams from a plurality of other cameras disposed at the vehicle, and wherein said display ECU processes the received data streams to generate surround view video images for displaying at the display screen for viewing by the occupant of the vehicle.

5. The vehicular vision system of claim 3, wherein said camera comprises a low voltage differential signaling (LVDS) serializer that receives raw image data and outputs serialized data to said first output connector, and wherein said display ECU comprises a LVDS deserializer that receives the first data stream output by said camera via said first output connector and provided to said display ECU.

6. The vehicular vision system of claim 1, wherein said camera comprises an image processor for processing image data captured by said imager, and wherein said first output connector receives processed image data processed by said image processor of said camera and the first data stream output by said camera via said first output connector is derived from the processed image data.

7. The vehicular vision system of claim 6, wherein said second data stream output by said camera via said second output connector is derived from raw image data captured by said imager and not processed by said image processor of said camera.

8. The vehicular vision system of claim 1, wherein said first and second output connectors comprise first and second coaxial connectors, respectively.

9. The vehicular vision system of claim 8, wherein said first and second coaxial connectors comprise a dual coaxial connector header that comprises a pair of spaced apart coaxial connectors disposed at a circuit board of said camera.

10. The vehicular vision system of claim 9, wherein a rear camera housing of said camera has a dual coaxial connector that electrically connects to said dual coaxial connector header during assembly of said camera, and wherein said dual coaxial connector of said rear camera housing is configured to electrically connect to respective leads of a wire harness of the vehicle.

11. A vehicular vision system, said vehicular vision system comprising:
a camera disposed at a vehicle and having a field of view exterior of the vehicle;
wherein said camera comprises an imager that captures image data;
wherein said camera comprises a first output connector and a second output connector, and wherein, during operation of said camera, a first data stream is output by said camera via said first output connector and a second data stream is output by said camera via said second output connector;
wherein said camera comprises (i) a first low voltage differential signaling (LVDS) serializer that receives raw image data captured by said imager and outputs serialized data to said first output connector, and (ii) a second LVDS serializer that receives raw image data captured by said imager and outputs serialized data to said second output connector;
a first electronic control unit (ECU) that receives the first data stream output by said camera via said first output connector;
a second electronic control unit (ECU) that receives the second data stream output by said camera via said second output connector;
wherein said second ECU comprises an image processor that processes the second data stream for at least one driving assist feature of the vehicle; and
wherein said first ECU receives the first data stream and processes the first data stream at an image processor of said first ECU and generates a video output for displaying video images derived from the first data stream at a display screen disposed in the vehicle for viewing by an occupant of the vehicle.

12. The vehicular vision system of claim 11, wherein said first ECU receives the first data stream output by said camera via said first output connector and receives data streams from a plurality of other cameras disposed at the vehicle, and wherein said first ECU processes the received data streams to generate surround view video images for displaying at said display screen for viewing by the occupant of the vehicle.

13. The vehicular vision system of claim 11, wherein said first and second output connectors comprise first and second coaxial connectors, respectively.

14. The vehicular vision system of claim 13, wherein said first and second coaxial connectors comprise a dual coaxial connector header that comprises a pair of spaced apart coaxial connectors disposed at a circuit board of said camera.

15. The vehicular vision system of claim 14, wherein a rear camera housing of said camera has a dual coaxial connector that electrically connects to said dual coaxial connector header during assembly of said camera, and wherein said dual coaxial connector of said rear camera housing is configured to electrically connect to respective leads of a wire harness of the vehicle.

16. A vehicular vision system, said vehicular vision system comprising:
a camera disposed at a vehicle and having a field of view exterior of the vehicle;
wherein said camera comprises an imager that captures image data;
wherein said camera comprises a first output connector and a second output connector, and wherein, during operation of said camera, a first data stream is output by said camera via said first output connector and a second data stream is output by said camera via said second output connector;
wherein said camera comprises a first image processor for processing image data captured by said imager;
wherein said camera comprises (i) a first low voltage differential signaling (LVDS) serializer that receives processed image data processed by said first image processor, and that outputs serialized data to said first output connector, and (ii) a second LVDS serializer that receives image data captured by said imager and outputs serialized data to said second output connector;
a display device that receives the first data stream output by said camera via said first output connector;
an electronic control unit (ECU) that receives the second data stream output by said camera via said second output connector;
wherein said ECU comprises a second image processor that processes the second data stream for at least one driving assist feature of the vehicle; and
wherein said display device receives the first data stream and displays video images derived from the first data stream at a display screen of said display device for viewing by an occupant of the vehicle.

17. The vehicular vision system of claim 16, wherein said second data stream output by said camera via said second output connector is derived from raw image data captured by said imager and not processed by said first image processor.

18. The vehicular vision system of claim 16, wherein said first and second output connectors comprise first and second coaxial connectors, respectively.

19. The vehicular vision system of claim 18, wherein said first and second coaxial connectors comprise a dual coaxial connector header that comprises a pair of spaced apart coaxial connectors disposed at a circuit board of said camera.

20. The vehicular vision system of claim 19, wherein a rear camera housing of said camera has a dual coaxial connector that electrically connects to said dual coaxial connector header during assembly of said camera, and wherein said dual coaxial connector of said rear camera housing is configured to electrically connect to respective leads of a wire harness of the vehicle.
